(19) United States
(12) Patent Application Publication
(10) Pub. No.: US 2005/0050100 A1
(43) Pub. Date: Mar. 3, 2005

(54) Method for recording and displaying double-byte font set (DBCS) on digital recording/playing device

(75) Inventor: Yuan-Chang Chin, Taipei (TW)

Correspondence Address: TROXELL LAW OFFICE PLLC, SUITE 1404, 5205 LEESBURG PIKE, FALLS CHURCH, VA, 22041, US

(73) Assignee: Ali Corporation

(21) Appl. No.: 10/729,979

(22) Filed: Dec. 9, 2003

(30) Foreign Application Priority Data
Aug. 29, 2003 (TW) 92124049

(51) Int. Cl. G06F 7/00

(52) U.S. Cl. 707/104.1

(57) ABSTRACT

The present invention relates to a method for recording and displaying double-byte font set (DBCS) on a digital recording/playing device. This method is suitable for playing and editing the title or the filename of the compact disk (CD). This method comprises: storing a font file including various languages in a storage medium to be read by the digital recording/playing device; building a font recording space in a compact disk-recordable (CD-R); recording the font file in the font recording space; inputting an inside code to specify a font code in the font file; recording the inside code in the compact disk-recordable (CD-R); searching the font code in the font file mapping to the inside code; the digital recording/playing device reading the searched font code; and updating the on screen display (OSD) based on the font code.

### BACKGROUND OF THE INVENTION

1. Field of the Invention

The present invention relates to a method for recording and displaying DBCS on a digital recording/playing device, and particularly, to a method for editing the font of the title or the filename of the compact disk (CD).

2. Description of the Prior Art

Nowadays, the home use recording/playing device is developed to apply the digital recording/playing technology. As more and more information appliance manufactures produce the DVD recorders, the DVD recording becomes very popular and commonly applied in the field of the personal computer. The DVD recording not only makes it more convenient to store and edit the digital images, and provides a friendly user interface and excellent image and video qualities. The DVD recording can be used to record the television programs, to transferably record the images from the video tapes, and to record the images processed and stored by DV, and can provide the good quality images without distortion and reserve permanently the clear and sharp images and video data.

Since the digital recording/playing device applying the digital recording/playing technology is developed, it swiftly becomes the consumer's favorite because it can provide the best video storage quality and the greater capacity. The consumer is free from the worry of the deterioration of the recorded images caused by the mist and dust, and therefore, the consumer can permanently reserve the images.

Presently, the digital recording/playing device can play the DVD, VCD (SVCD), CDDA, MP3 disc, and also can record the video data on the DVD disc. In addition, in the recording process, the function is provided to the user to edit the data of the title and modify the filename. Take the present digital recording/playing device for example, in the process of editing the data, the emerged on screen display (OSD), as shown in FIG. 1, is provided with the user interface displaying the number symbols and the English characters. Therefore, the user can use the remote controller for selection and inputting so as to edit the data of the title or filename by applying the numbers or the English fonts.

However, because the present digital recording/playing device only provides the function of inputting numbers and the English characters, the user's requirement cannot be satisfied when the user has to performing the editing by using other fonts, such as the traditional Chinese, the simplified Chinese, the Japanese, and the Korean fonts. Even though the other fonts are installed inside the digital recording/playing device, in the process of editing and inputting, the user's need cannot be well served due to the lack of some fonts. Furthermore, to install the other fonts in the digital recording/playing device will require more space in the FLASH-Rom (the memory for storing the program codes) to be occupied, and increase the production cost. For example, when the user wants to apply the traditional Chinese for inputting, the user has to use the remote controller to search and select the certain one among the thousands of Chinese fonts. This makes the editing very difficult, inconvenient, and time-consuming, and therefore, it is unacceptable to the user.

### SUMMARY OF THE INVENTION

The object of the present invention is to provide a DBCS recording and displaying method for a digital recording/playing device. This method is capable of editing the title or the filename of the compact disk-recordable (CD-R) by using the multi-language font.

In order to achieve the mentioned object, the present invention provides a DBCS recording method for a digital recording/playing device. The method comprises:

Building a font recording space in a compact disk-recordable (CD-R); recording at least one font file (the local language of the end-user) in the font recording space; inputting an inside code mapping to the font file; and recording the inside code in the compact disk-recordable (CD-R).

In order to achieve the mentioned object, the present invention provides a font displaying method for a digital recording/playing device. The method is suitable for a compact disk-recordable (CD-R) having a font file and an inside code stored thereon. The method comprises: reading the data of the compact disk-recordable (CD-R); searching the font code in the font file mapping to the inside code; reading the searched font code; and updating the on screen display (OSD) based on the font code.

In order to achieve the mentioned object, the present invention provides a computer readable recording medium having a program stored thereon. The program is applied in a digital recording/playing device for recording the font on a compact disk-recordable (CD-R). The program executes the steps: building a font recording space on the compact disk-recordable (CD-R); recording at least one font file in the font recording space; inputting an inside code mapping to the font file; and recording the inside code on the compact disk-recordable (CD-R).

In order to achieve the mentioned object, the present invention provides a computer readable recording medium having a program stored thereon. The program is applied in a digital recording/playing device for reading the compact disk-recordable (CD-R) having the font file and the inside code stored thereon. The program executes the following steps: reading the data of the compact disk-recordable (CD-R); searching the font code in the font file mapping to the inside code; reading the searched font code; and updating the on screen display (OSD) based on the font code.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of an on screen display (OSD) of a prior art digital recording/playing device;

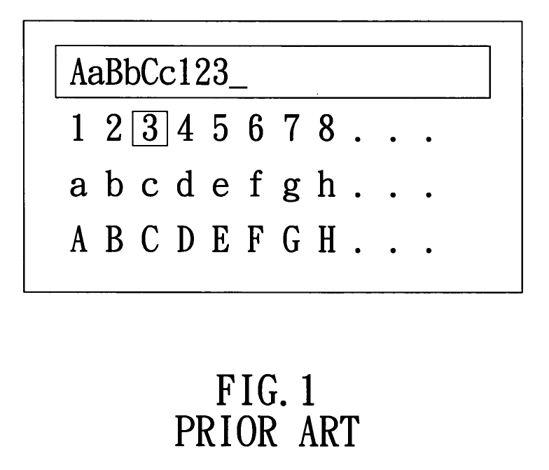

FIG. 2 is a perspective diagram of applying a digital recording/playing device according to the present invention;

FIG. 3 is a perspective diagram of data structure of a font data set;

FIG. 4 is a flowchart of the control process according to the present invention; and

FIGS. 5A and 5B are perspective diagrams of the on screen display (OSD) according to the present invention.

### DETAILED DESCRIPTION OF THE PREFERRED EMBODIMENT

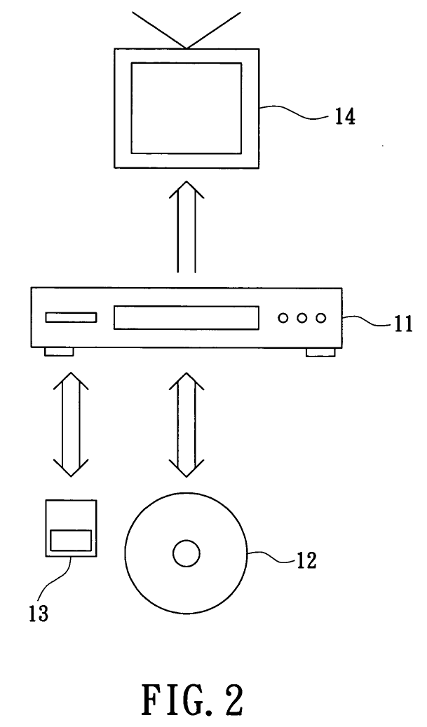

Please refer to FIG. 2. FIG. 2 is a perspective diagram of applying a digital recording/playing device according to the present invention. The present invention relates to a font recording and displaying method for a digital recording/playing device. The digital recording/playing device 11 having the recording function is used for recording the font data on the compact disk-recordable (CD-R) 12, and displaying the content of the font data recoded on the compact disk-recordable (CD-R) 12 on a television 14. Therefore, the user can use the digital recording/playing device 11 to edit/update the data of the title or the filename of the compact disk (CD) 12. More particularly, the user can edit the data by multi-language font.

Therefore, the present invention stores the font file on the storage medium at first. That storage medium can be the hard disk installed in the digital recording/playing device 11 or the memory card 13 inserted in the memory-card slot of the digital recording/playing device 11. The memory card 13 can be CF, SM, MS, SD or MMC. The content of the font file can be traditional Chinese, simplified Chinese, Korean, Japanese, Thai language, Arabic or other language, which is represented by the double-byte font set.

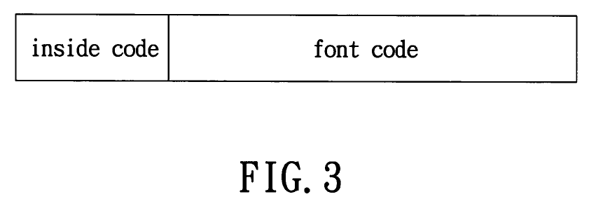

The font file has a plurality of font data sets stored therein. Please refer FIG. 3. FIG. 3 is a perspective diagram of data structure of a font data set. Each of the font data sets stored in the font file is composed of the inside code and the font code. The inside code applied in the present invention is the double-byte font set (DBCS). The DBCS is used for representing a language font set, and the font code is the bitmap font of 24×24 (default). In this way, the font code in each of the font data set has its mapping inside code to be inputted.

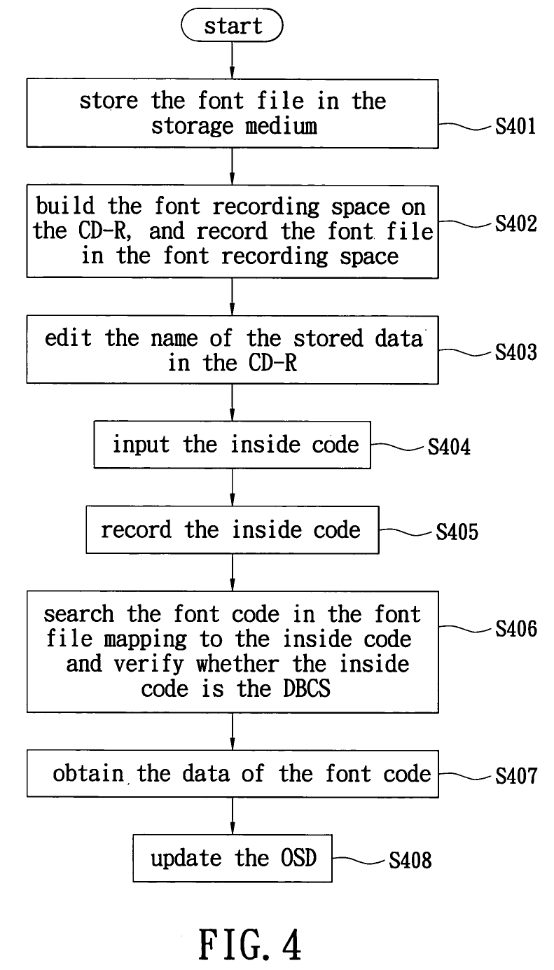

Please refer to FIG. 4. FIG. 4 is a flowchart of the control process according to the present invention. The control process comprises the follows. First, the font file is stored in the storage medium (S401) so as to make the digital recording/playing device capable of reading the hard disk or the memory card for obtaining the data of the font file. Then, the font recording space is built on the compact disk-recordable (CD-R), and the font file is recorded in the font recording space (S402). As for the compact disk-recordable (CD-R) of DVD_RW or DVD+RW, the digital recording/playing device will build a file wrapper index under the root directory of the compact disk-recordable (CD-R) to be the font recording space for storing the font file. As for the DVD_RW, the name of the file wrapper index cannot be the same as the DVD_RTAV, and as for the DVD+RW, the name of the file wrapper index cannot be the same as the DVD_TS or the DVD_RM.

Next, the name of the stored data in the compact disk-recordable (CD-R) is edited (S403) so as to make the user capable of editing/updating the data of the title or the filename of the compact disk-recordable (CD-R) by means of the user interface. Thereafter, the inside code is inputted (S404) so as to specify the data of the font code in the font file to be read. Then, the inside code is recorded (S405). Namely, the result of the editing the name of the compact disk-recordable (CD-R) is recorded as the inside code.

Next, the font code in the font file mapping to the inside code is searched, and it is verified whether the inside code is the DBCS (S406). Because the font file has a plurality of font data sets stored therein, and each of the font data sets is composed of the inside code and the font code, the inputted inside code is mapping to one font code. Furthermore, it is verified whether the first number of the inputted inside code is greater than 80 (Hex). It yes, it is determined that the inputted inside code is the DBCS. Otherwise, the inputted inside code is the ASCH. After performing the mentioned steps, the font code is obtained (S407). Therefore, the digital recording/playing device will update the on screen display (OSD) based on the font code (S408) so as to display the edited title or filename of the compact disk-recordable (CD-R).

Specifically, when the user operates the digital recording/playing device for editing the title or the filename of the compact disk-recordable (CD-R) by using the multi-language font, during the steps of S401-S405, the user stores the font file in the storage medium in advance so as to make the digital recording/playing device capable of reading the font file and recording the font file in the font recording space of the compact disk-recordable (CD-R). In other words, the compact disk-recordable (CD-R) has had the font code stored thereon, and therefore, in the process of editing the title or the filename, the user can use the remote controller to input the inside code mapping to the font code via the user interface, and to record the inputted inside code on the compact disk-recordable (CD-R). In this way, the object of the present invention to use the multi-language font to edit the title or the filename of the compact disk-recordable (CD-R) can be achieved.

During the steps of S406-S408, the edited title or the filename of the compact disk-recordable (CD-R) is displayed. When the digital recording/playing device reads the compact disk-recordable (CD-R) having the font file and the inside code stored thereon, the digital recording/playing device has to find out the corresponding font code in the font file recorded on the compact disk-recordable (CD-R) because the title or the filename of the compact disk-recordable (CD-R) is recorded as the inside code. The font file comprises a plurality of font data sets, and each of the font data set is composed of the inside code and the font code. Therefore, in the font file, there is only one font code mapping to the inside code, and only that font code is found out. After the digital recording/playing device obtains the font code of the title or the filename, the on screen display (OSD) will be updated so as to displaying the edited title or the filename of the compact disk-recordable (CD-R) by using the multi-language font.

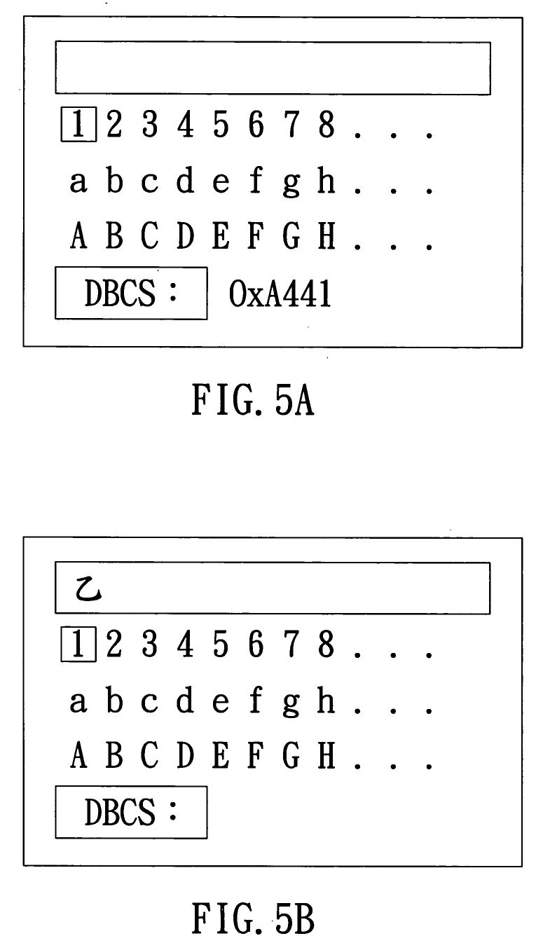

Please refer to FIGS. 5A and 5B. By applying the method of the present invention, on the displayed user interface during the operation, the item for the DBCS will be showed for indicating the user to input the inside code. As shown in FIG. 5A, the inside code selected and inputted by the user via the remote controller is “0×A441”, and as shown in FIG. 5B, the font code, “ [symbol] ”, mapping to the inputted inside code of FIG. 5A is displayed. Integrally speaking, the present invention is provided to overcome the drawback of the prior art capable of only using the English characters or numbers to edit the title or the filename of the compact disk-recordable (CD-R). In the present invention, the font file is recorded on the compact disk-recordable (CD-R), and the inside code is inputted for specifying the font code in the font file. In this way, the object of the present invention to apply multi-language font to edit the title or the filename of the compact disk-recordable (CD-R) can be achieved.

In summary, the font recording and displaying method for the digital recording/playing device according to the present invention has the following advantages:
(1) By recording the font file on the compact disk-recordable (CD-R), the problem of the limitation of the memory space in the digital recording/playing device can be resolved. That inside memory space is too small to record various language fonts, and therefore, the compact disk (CD) is applied to provide the greater memory space for storing the various font data so as to meet the requirements in different states.

(2) By inputting the inside code, the font code in the font file mapping to the inside code is specified so as to swiftly find out the correct font data among the numerous fonts.

(3) In the process of editing the title or the filename of the compact disk-recordable (CD-R), the user can choose and specify one preferred fonts among different language fonts according to the need, and the user's selections for the fonts are not limited to the common English characters or numbers any more.

Those skilled in the art will readily observe that numerous modifications and alterations of the device may be made while retaining the teachings of the invention. Accordingly, the above disclosure should be construed as limited only by the metes and bounds of the appended claims.

1. A method for font recording on a digital recording/playing device comprising:
building a font recording space in a compact disk-recordable (CD-R);
recording at least one font file in the font recording space;
inputting an inside code mapping to the font file; and
recording the inside code in the compact disk-recordable (CD-R).

2. The method of claim 1, wherein the font recording space is a file wrapper index.

3. The method of claim 1 further comprising:
editing the name of the data stored in the compact disk-recordable (CD-R).

4. The method of claim 1, wherein the font file is stored in a storage medium.

5. The method of claim 4, wherein the storage medium is a hard disk installed in the digital recording/playing device.

6. The method of claim 4, wherein the storage medium is a memory card.

7. The method of claim 7, wherein the memory card is one of CF, SM, MS, SD, MMC.

8. The method of claim 1, wherein the font file has a plurality of font data sets stored therein, and the font data set is composed of the inside code and the font code.

9. The method of claim 8, wherein the font code is a bitmap font.

10. The method of claim 1, wherein the inside code is a double-byte font set (DBCS).

11. The method of claim 1, wherein the inside code is inputted via a user interface.

12. A method for displaying font on a digital recording/playing device applied in a compact disk-recordable (CD-R) having a font file and an inside code stored thereon, the method comprising:
reading the data of the compact disk-recordable (CD-R);
searching a font code in the font file mapping to the inside code;
reading the searched font code; and
updating the on screen display (OSD) based on the font code.

13. The method of claim 12, wherein the font code is a bitmap font.

14. The method of claim 12, wherein the inside code is a double-byte font set (DBCS).
